(19) United States
(12) Patent Application Publication
(10) Pub. No.: US 2016/0364998 A1
(43) Pub. Date: Dec. 15, 2016

(54) EDUCATIONAL LITERARY COMPOSITION SYSTEM

(71) Applicant: Gilbert Newman PERKINS, Reston, VA (US)

(72) Inventor: Gilbert Newman Perkins, Reston, VA (US)

(21) Appl. No.: 15/120,914

(22) PCT Filed: Feb. 24, 2015
(86) PCT No.: PCT/US15/17311

§ 371 Date: Aug. 23, 2016

Related U.S. Application Data
(60) Provisional application No. 61/943,756, filed on Feb. 24, 2014.

(51) Int. Cl. G09B 19/00; G06F 17/24; G09B 5/10

(52) U.S. Cl. CPC G09B 19/00; G09B 5/10; G06F 17/241

(57) ABSTRACT

Systems are disclosed for annotating educational materials and composing new literary works.

### RELATED APPLICATION

This application claims priority benefit of U.S. Provisional Application No. 61/943,756, filed Feb. 24, 2014, and incorporated herein for all purposes.

### FIELD

The embodiments described here relate to systems for annotating educational materials and composing new literary works.

### BACKGROUND

The Common Core State Standards Initiative is an education initiative in the U.S. that details what K-12 students should know in English language arts and mathematics at the end of each grade. Sponsored by the National Governors Association (NGA) and the Council of Chief State School Officers (CCSSO), the initiative seeks to establish consistent education standards across the states, as well as ensure that students graduating from high school are prepared to enter two- or four-year college programs or enter the workforce.

The stated goal of the English and Language Arts and Literacy in History/Social Studies, Science, and Technical Subjects standards is to ensure that students are college and career ready in literacy no later than the end of high school. There are five key components to the standards for English and Language Arts: Reading, Writing, Speaking and Listening, Language, and Media and Technology. The essential components and breakdown of each of these key points within the standards are as follows:

Reading: As students advance through each grade, there is an increased level of complexity to what students are expected to read and there is also a progressive development of reading comprehension so that students can gain more from what they read. There is no reading list to accompany the reading standards. Instead, students are expected to read a range of classic and contemporary literature as well as challenging informative texts from an array of subjects. This is so that students can acquire new knowledge, insights, and consider varying perspectives as they read. Teachers, school districts, and states are expected to decide on the appropriate curriculum, but sample texts are included to help teachers, students, and parents prepare for the year ahead. Exemplar texts include works by authors such as Ovid, Atul Gawande, Voltaire, Shakespeare, Turgenev, Poe, Robert Frost, Yeats, Nathaniel Hawthorne, Amy Tan, and Julia Alvarez. There is some critical content for all students—classic myths and stories from around the world, foundational U.S. documents, seminal works of American literature, and Shakespeare's writings—but the rest is left up to the states and the districts.

Writing: The driving force of the writing standards is logical arguments based on claims, solid reasoning, and relevant evidence. The writing also includes opinion writing even within the K-5 standards. Short, focused research projects, similar to the kind of projects students will face in their careers as well as long-term, in-depth research is another piece of the writing standards. This is because written analysis and the presentation of significant findings is critical to career and college readiness. The standards also include annotated samples of student writing to help determine performance levels in writing arguments, explanatory texts, and narratives across the grades.

Speaking and listening: Although reading and writing are the expected components of an ELA curriculum, standards are written so that students gain, evaluate, and present complex information, ideas, and evidence specifically through listening and speaking. There is also an emphasis on academic discussion in one-on-one, small-group, and whole-class settings, which can take place as formal presentations as well as informal discussions during student collaboration.

Language: Vocabulary instruction in the standards takes place through a mix of conversations, direct instruction, and reading so that students can determine word meanings and can expand their use of words and phrases. The standards expect students to use formal English in their writing and speaking, but also recognize that colleges and 21st century careers will require students to make wise, skilled decisions about how to express themselves through language in a variety of contexts. Vocabulary and conventions are their own strand because these skills extend across reading, writing, speaking, and listening.

Media and technology: Because media and technology are intertwined with every student's life and in-school experience in the 21st century, skills related to media use, which include the analysis and production of various forms of media, are also included in these standards. The standards include instruction in keyboarding, but do not mandate the teaching of cursive handwriting. As of late 2013, seven states had elected to maintain teaching of cursive: California, Idaho, Indiana, Kansas, Massachusetts, North Carolina, and Utah.

Whether or not relating to the Common Core State Standards Initiative, student engagement is a key driver of effective implementation of compliance with educational standards. The enhancement of student engagement through various mechanisms, as measured by student performance against educational standards, remains a goal of the educational process. Accordingly, it would be beneficial to provide educators with another mechanism to achieve this goal.

### SUMMARY OF THE INVENTION

The various embodiments disclosed here include innovative systems for annotating educational materials and composing original literary or musical works. The systems provide a student or students with the tools to annotate increasingly complex text, craft advanced figurative language expressions, and produce written compositions using select literary devices in their own original works.

The systems may include the partitioning and juxtaposing of select text compositions from song lyrics, such as urban music lyrics, and U.S. Common Core State Standards for English Language Arts texts and other educational materials for the composition of new literary works.

According to an embodiment of the systems described here, select literary devices in song lyric(s) can be identified and isolated to allow the visual or audible illustration of the same or similar select literary devices embodied in educational material, such as novels, speeches, short stories, and poetry. The select literary device can be reviewed, both visibly and audibly, in both contexts (the song and the juxtaposed textual information). Once the literary device is reviewed in the song lyric (as selected text) and in the educational material, the select literary device can be used by a student to compose his or her own, original literary work; or used by any number of students to compose their own, original literary work(s). Additionally of alternatively, students can write and record their own lyrical compositions. The student(s) thereby experience the literary device from an audio, visual, and production perspective.

### DETAILED DESCRIPTION

The present embodiments include innovative systems for annotating educational materials and composing original literary works. The systems provide students with the tools to annotate increasingly complex text, advanced figurative language expressions, and produce written compositions using select literary devices in their own original works.

The systems may include the partitioning and juxtaposing of select text compositions from contemporary language works with select text of U.S. Common Core State Standards for English Language Arts texts and other educational materials to analyze the works and compose original literary or music works.

The present invention is not limited to the particular methodology, compounds, materials, manufacturing techniques, uses, and applications described herein, as these may vary. The terminology used herein is used for the purpose of describing particular embodiments only, and is not intended to limit the scope of the present invention. The singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the term “or” is inclusive unless modified, for example, by “either.” Structures described are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures.

All patents and other publications identified are incorporated herein by reference for the purpose of describing and disclosing, for example, the methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason.

The educational systems in many U.S. urban centers suffer from the deficient teaching and learning of basic reading and writing skills among students. Student engagement is a key driver of effective implementation of educational standards compliance. The enhancement of student engagement through various mechanisms, as measured by student performance against educational standards, is a goal of the educational process. The embodiments disclosed here provide educators with another mechanism to achieve this goal.

As disclosed here, contemporary language includes, for example, the lyrics of urban music or other songs, code/computer learning programming languages, social media lingo, and text message language. A song, as used here, is a musical composition including music and lyrics. Urban music may be defined as the music and lyrics provided through the music genres classified as, but not necessarily limited to, Hip-hop, Rap, Gangsta, Alternative, Reggae, R&B, Gospel, Blues, G-funk, New School, Golden Age, Turntablism, DJing, MCing, SingJing, East Coast, Atlanta, Southern, West Coast, New Age, Trance, Flipping, Disco rap, Toasting, Chatting, Neo Soul, or a mix of these influences (e.g., fusion genres).

As disclosed here, literary device or literary terms, may include any word expression written for dramatic or emotional effect or any word expression that utilizes typical structure, including literary elements, literary techniques and non-literal traits, including allegory, alliteration, allusion, amplification, anagram, analogy, anastrophe, antagonist, anthropomorphism, antithesis, aphorism, archetype, assonance, asyndeton, authorial intrusion, bibliomancy, bildungsroman, cacophony, caesura, characterization, chiasmus, circumlocution, comedy, conflict, connotation, consonance, denotation, deus ex machina, dialogue, diction, doppelganger, ekphrastic, epilogue, epithet, euphemism, euphony, faulty parallelism, flashback, foil, foreshadowing, hyperbaton, hyperbole, imagery, internal rhyme, inversion, irony, juxtaposition, kennings, malapropism, metaphor, metonymy, mood, motif, narrative, negative capability, nemesis, onomatopoeia, oxymoron, paradox, pathetic fallacy, periodic structure, periphrasis, personification, plot, point of view, polysyndeton, portmanteau, prologue, protagonist, puns, rhyme scheme, rhythm & rhyme, satire, setting, simile, spoonerism, stanza, stream of consciousness, syllepsis, symbol, synecdoche, synesthesia, syntax, theme, tone, tragedy, understatement, verisimilitude, and verse.

As disclosed here, a student may include any person engaged in formal or informal education in any medium, such as real-time classroom instruction, on-line or distance education or tutoring. The educational processes contemplated herein include self-taught and self-paced applications following embodiments of the systems in any visual or auditory format, including digital delivery through mobile device, computer, or Cloud-based server system.

As disclosed here, an educational standard may include teaching and learning standards developed by the federal, state, city or local authorities as well as customs and practices adopted or proposed for educational purposes. The educational standard according to the invention may also include those set forth in the U.S. Common Core State Standards Initiative.

As disclosed here, the compliance with, or satisfaction or completion of an educational standard may include the use of any adopted or proposed assessment tool to measure success or failure to meet such a standard.

As disclosed here, the educational material may include any text or language-based expression, including literature, reading material, and literary curricula required or recommended with respect to a method of instruction, including a class/course offering. The educational material may be presented in any medium, including printed matter and digital publication as well as speakers, live presentations, voices, and music, available through tablets, phones, computers, projectors, screens, and boards.

An example embodiment may include a system for enabling student use of select literary devices in original written compositions, comprising the steps of: (a) reviewing select text passages from urban music lyrics, both audibly and visually; (b) highlighting, audibly and visually, the select literary device or technique in the text passages; (c) reviewing select text passages from Common Core English Language Arts texts or other select texts including religious, rhetorical, historical, fantasy, and scientific texts; (d) highlighting, both audibly and visually, the same select literary device in the Hip-hop text as in the Common Core English Language Arts text or corresponding text, including religious, rhetorical, historical, fantasy, and scientific texts; (e) placing each highlighted section next to the other highlighted section and juxtaposing each; (f) identifying the sameness in use of technique; (g) manifesting a subject matter or idea to express; (h) expressing the select idea or select subject matter using the literary device reviewed/highlighted; and (i) composing the new literary work.

As disclosed here, highlighting, audibly and visually, the select literary device in the text passages may include the action of visibly and audibly emphasizing a particular section of the lyrics. The visible highlighting may be done through physical highlighting with bright yellow blocks behind the words, italicizing, underlining, bolding the words, or any other demarcation to draw attention to a particular passage of the select passages. The audible highlighting may be done through projecting the hip-hop song samples audibly through any speaker or audio medium.

As disclosed here, reviewing select text passages from the English Language Arts texts as well as other select texts including religious, rhetorical, historical, and fantasy may include addressing the source text of which the student is learning. Common examples are novels, short stories, speeches, poems, plays, and other literary art taught in schools.

As disclosed here, highlighting, both audibly and visually, the same select literary device in both the urban music text (lyric) and the English Language Arts or corresponding text may include the action of visibly and audibly emphasizing a particular section of the texts to annotate the literary device present in selected texts. The visible highlighting may be done through physical highlighting with bright yellow blocks behind the words, italicizing, underlining, bolding the words, or any other demarcation to draw attention to a particular passage of the select passages. The audible highlighting may be done through projecting the literature selection audibly through any speaker or audio medium.

As disclosed here, placing each highlighted section next to the other, juxtaposing the urban music song excerpt with the English literary work excerpt, may include the synching of the two excerpts together so that students may annotate both the music song lyric and the literary work using the same literary device.

As disclosed here, identifying the sameness in use of technique may include student consideration, evaluation, and understanding individually, with another or peer-to-peer, and identifying, recognizing or knowing the use and motivation behind the use of the select literary device in each of the excerpts. The platform for a peer-to-peer discussion may occur in-class, remotely, digitally, through networks, or any other suitable technology medium.

As disclosed here, manifesting a subject matter or idea to express may include the development of a targeted idea or expressible concept. Through focusing on a specific idea, student(s) can apply their learning toward their own production.

As disclosed here, expressing the select idea or select subject matter may include using the literary device that was reviewed. This manifestation may include a student production. In this example, student(s) create original works from study of the selected educational material but approach the writing with the writers' tool that was previously studied via literary device.

As disclosed here, composing the original work may include student writing, presenting, or recording new work exhibiting use of the select literary device and technique. This work may be evaluated or measured against educational standards to determine compliance, satisfaction, or completion of such standards using any assessment tools known in the art.

The embodiments herein provide for contemporary language integration that integrates lyrics of urban music, code/computer learning programming languages, social media lingo, and text message language into traditional classroom literature for enhanced literacy. Presenting to an academically and ethnically diverse group of students, this approach has proved able to transcend cultural and achievement gaps to make literature relevant and interesting.

The selection of urban music or urban music excerpts may include analysis of the evidence of literary technique or structure in this passage great enough to warrant an examination and whether students will benefit from this example in the lesson plan. The selection of urban music or urban music excerpts may include exclusion of lyrics that feature profanity, sexually explicit lyrics or content, drug use glorification, derogatory language, or personally harmful content.

The selection of literary devices in songs provides for an analogical algorithmic model to compare disparate literary texts. The analogy developed may be referred to as a real economy analogy of literature. Here, the production function in the real economy is likened to the language economy's linguistic functions. The economy analogy hosts the elements of scarce resources, input to output ratio, and technology. For the language economy, the technology is the literary device. The literary device plays a technological role the same as innovation does in the real economy.

Students can be guided through a text based on what the writer is doing (i.e., identification of literary device(s)) before annotating what the writer is saying; students can then evaluate and score text. This exercise can be presented as an objectively scored game in which students highlight literary devices in texts.

For example, through this analogous application, Common Core English Language Arts texts, such as THE GREAT GATSBY written by F. Scott Fitzgerald (1925), may be reviewed for the use of the literary device “extended simile.” Once the extended simile present in the text has been identified, the same literary device may be found in the urban music for example, the lyrics of rappers Andre 3000, Rakim, Lil Wayne, Kanye West, Tupac, Notorious B.I.G., and Jay Z. Other literary techniques can also be found in urban music: for example, the character-building methods of Jay-Z and the Notorious B.I.G. resemble those of H. G. Wells; the form of the standard hip-hop song is three verses of 16 bars written to various beats-per-minute patterns, which mirrors Shakespeare's use of iambic pentameter; the Nas lyric I Gave You Power presents an anthropomorphism in which the writer takes the role of a gun and tells the story of the gun being used from a human perspective, which is a literary device used in classical literature. Other hip-hop artists have mastered the nuances and transmutation of English language; and articulated an etymological perspective with an original slang lexicon presenting the story of American life. Thus, urban music can be used to introduce students to a literary device and provide interesting context and parallelism for analysis of traditional texts.

Upon review of the literary device in both text and lyrics, and a close annotation of both text and lyrics, student(s) may compose an original literary composition using this extended metaphor. For example, a student may compose a Tweet (140 character message) in using an identified and analyzed literary device. Alternatively, having first identified literary devices and then analyzed the literary content, a student may Tweet the main theme of the literature. The student(s) may be asked to present original compositions, which may also be transferred onto any suitable recordable or recording medium.

The systems of the embodiments may be used to develop an improved curriculum upon the English Language Arts curriculum in primary schools, to provide students with a full-sensory experience to learn and apply literature, as observable through a synthesis of literature, enhanced comprehension at higher levels and the production of creative and original works. The systems of the embodiments may also facilitate decreased truancy, curtail disruptive behavior, and overcome deficient performance.

### EXAMPLES

### Example 1

### Guided Annotation of Imagery in BEOWULF

The system disclosed here may be applied to the educational material BEOWULF (Anonymous; W. W. Norton & Co., 2001). Hip-hop artist Kendrick Lamar wrote and performed his album entitled GOOD KID, M.A.A.D. CITY (Top Dawg Ent., Aftermath Ent., Interscope Records, 2012). Select text passages (lyrics) from this album are used to highlight the essential elements of an ‘Epic poem’ along with ‘Imagery’ detailing those essential elements. To highlight the imagery and description of the essential ‘Monster’ element of epic literature, the citation is to Kendrick Lamar's Good Kid:
Look inside these walls and you see them having withdrawals of a prisoner on his way|trapped inside your desire to fire bullets that stray|track attire just tell you I′m tired and ran away I should ask a choir what do you require|To sing a song that requires me to have faith|As the record spins I should pray|For the record I recognize that I'm easily prey|I got ate alive yesterday. I got animosity building. It's probably big as a building. Me Jumping off the roof, is me just playing it safe|But what am I suppose to do when the topic is red or blue?|And you understand that I ain't,|But know I'm accustomed to|Just a couple that look for trouble|And live in the street with rank|No better picture to paint than me walking from bible study and he called his homies because he had said he noticed my face from a function that had taken place they was wondering if I bang|Step on my neck and get blood on your Nike checks, I don't mind because one day you'll respect|The good kid, m.A.A.d city.

Highlight this passage as a passage using ‘Imagery’ to describe the monster that the hero, “Kendrick Lamar’ is up against in this epic/album.

In the epic poem/novel BEOWULF, our unknown author(s) describe the Monster, Grendel, which must be slain by Beowulf:
Out from the marsh, from the foot of misty Hills and bogs, bearing God's hatred, Grendel came, hoping to kill Anyone he could trap on this trip to high Herot. He moved quickly through the cloudy night, Up from his swampland, sliding silently toward that gold-shining hall. He had visited Hrothgar's Home before, knew the way—but never, before nor after that night, Found Herot defended so firmly, his reception so harsh. He journeyed, forever joyless, Straight to the door, then snapped it open, tore its iron fasteners with a touch, and rushed angrily over the threshold.

Highlight this passage as text using ‘Imagery’ to describe one of the essential elements of Epics: the Monster. Juxtaposing these two selections reveals the technique of ‘Imagery’ inside an epic poem. In BEOWULF, the Monster is Grendel: a mythical dragon-like monster. In Kendrick Lamar's album, the Monster is Gang-Violence Peer-pressure. Gang-Violence is detailed as wars between the Bloods and the Crips in Los Angeles, the setting of the album.

Students describe a large battle or fight they struggle with. That thing becomes, analogously, their ‘Monster’. Students write their own personal epic stories with all essential elements, centered around their ‘Monster.’ In addition, students may write and record their own Hip-hop compositions.

In one exercise, over 600 students were engaged and responded in collective annotation of BEOWULF and Kendrick Lamar's songs.

### Example 2

### Guided Annotation of Simile in THE GREAT GATSBY

The system disclosed here may be applied to the educational material THE GREAT GATSBY by F. Scott Fitzgerald (1925). Rapper and emcee Rakim (William Griffin, Jr.) performed the song When I'm Flowin (lyrics by M. L. Williams, W. Griffin et al.; Lyrics© Sony/ATV Music Publ'g LLC, Warner/Chappell Music, Inc., CAK Music Publ'g, Inc.; 18TH LETTER, Universal Records, 1997). Select text passages from these works are used to highlight the use of ‘simile’.

To highlight the simile, the citation is to Rakim et al., When I'm Flowin: “In a formation like a soldier. . . My Thoughts travel like an arrow. . . ” Another example lyric is by artist Kanye West, I Don't Like (Lyrics, Kayne West; produced by Kanye West, Noah Goldstein, The Twilite Tone & Young Chop, 2012): “The media crucified me like they did Christ. They want to find me not breathing like they did Mike.” Highlight this passage(s) as using similes to describe something/ make an author's point.

In the novel, THE GREAT GATSBY, Fitzgerald used simile to describe character events: “strolled back into the library, as if to a vigil beside a perfectly tangible body . . . “made the dim enlargement of Mrs. Wilson's mother which hovered like a ectoplasmo wall “tried to go became entangled in some wild strident argument which pulled me back, as if with ropes, into my chair . . . ” Highlight this passage as one using ‘Simile’ to describe character actions and events.

Juxtaposing these two selections reveals the technique of ‘Simile’ inside the texts. Students deconstruct the essential elements of a proper simile Students write their own personal form of literature exhibiting the use of simile In addition, students may write and record their own compositions.

In one exercise, thirty-five students worked in small groups to create their own hip-hop songs based on the theme ‘paradise,’ using the 48-bar structure with similes, connecting unlike things with, for example, “like” or “as” scattered throughout the lyrics. Each song was vastly difference from the next in content, but the structure of each was the same, indicating that students had learned and applied these literary devices.

Embodiments of the present invention described herein are exemplary only. One skilled in the art may recognize variations from the embodiments specifically described herein, which are intended to be within the scope of this disclosure. As such, the invention is limited only by the following claims. The present invention covers such variations provided that they come within the scope of the appended claims and their equivalents.

1. A system for annotating educational materials and composing new literary works capable of enhancing student performance as measured against educational standards.

2. The system of claim 1, wherein the educational material is a literary work.

3. The system of claim 2, wherein the annotating comprises identifying at least one literary device in the text of the literary work.

4. The system of claim 3, further comprising annotating at least one text of an urban music song (lyric) for at least one literary device.

5. The system of claim 4, further comprising comparing the annotated literary work with the annotated song lyric to characterize at least one literary device in common with the work and lyric.

6. The system of claim 4, wherein the annotating or comparing is done by at least one student.

7. The system of claim 6, further comprising the student composing a new literary work or lyric using or incorporating at least one compared literary device.

8. The system claim 1, wherein the annotating is done by machine.

9. The system of claim 2, wherein the literary work is one identified in the Common Core English Language Art.

10. A data base comprising the annotated educational materials of claim 3.
